(19) United States
(12) Patent Application Publication
(10) Pub. No.: US 2025/0279258 A1
(43) Pub. Date: Sep. 4, 2025

(54) MACHINE LEARNING METHOD FOR IDENTIFYING THE CRYSTAL PHASE DISTRIBUTION OF POLYCRYSTALLINE THIN FILMS IN NANODEVICES

(71) Applicant: East China Normal University, Shanghai City (CN)

(72) Inventors: Yonghui ZHENG, Shanghai City (CN); Yan CHENG, Shanghai City (CN); Yunzhe ZHENG, Shanghai City (CN); Yilin XU, Shanghai City (CN); Tianjiao XIN, Shanghai City (CN)

(73) Assignee: East China Normal University, Shanghai City (CN)

(21) Appl. No.: 18/592,576

(22) Filed: Mar. 1, 2024

(51) Int. Cl. H01J 37/26; G06F 30/27; G06F 111/14; H01J 37/28

(52) U.S. Cl. CPC H01J 37/265; G06F 30/27; H01J 37/28; G06F 2111/14; H01J 2237/2802

(57) ABSTRACT

The patent presents a machine learning technique to determine the crystal phase distribution of polycrystalline thin films in nanodevices. It involves adjusting simulation parameters of transmission electron microscope software to generate a database of simulation images. A dedicated convolutional neural network is then built based on specific crystallographic parameters. This network is trained on the image dataset obtained. Once trained, it analyzes transmission electron microscope images of grains within actual thin films to swiftly and accurately identify crystal phase distribution. This innovation replaces manual methods, enabling automatic and reliable identification of crystal phase distribution in real polycrystalline thin films.

### TECHNICAL FIELD

The present invention belongs to the field of microscopic image structure recognition of polycrystalline functional materials in nanodevices, and relates to a machine learning-assisted method for identifying the crystal phase distribution of polycrystalline functional materials.

### BACKGROUND ART

Since the 21^{st} century, the information industry such as computers and the Internet has been developing rapidly, the semiconductor industry has gradually become an important foundation for the country's economic development, symbolizing the level of modern science and technology. As the basic unit of semiconductor integrated circuits, the size of electronic components such as resistors, capacitors, inductors, and transistors is also shrinking along Moore's law, and the device size has reached the nanoscale. For example, the gate size in the current mainstream transistors is 12 nanometers, while the core storage unit in the next-generation phase change memory and ferroelectric memory is generally tens of nanometers. The miniaturization of the device can improve the density and performance of the device. However, to further optimize its performance, a deeper understanding of its working principle and failure mechanism at a more microscopic scale is needed. Consequently, this demands higher standards for the structural characterization of the device. In the Ge₂Sb₂Te₅-based phase change memory (thin film thickness is about 50 nm), the thin film material undergoes a reversible phase transition between amorphous and face-centered cubic phase nanocrystals (grain size is about 10 nm), when the electric field intensity is too large, the thermodynamically more stable hexagonal phase grains are obtained. The structure of these two phases is similar, but the hexagonal phase consumes more power, which is not conducive to information storage, so it is desirable to try to avoid the hexagonal phase. In hafnium zirconium oxide (HZO)-based ferroelectric memory (thin film thickness is about 10 nm), the constituent atoms of ferroelectric orthorhombic (O) nanocrystals (grain size is about 10 nm) inside the thin film will undergo directional migration under the influence of an electric field to enable information storage. At present, due to the immature device fabrication process, there are other crystal structure nanocrystals in the hafnium zirconium oxide thin film, such as the paraelectric monoclinic (M) phase and the antiferroelectric tetragonal (T) phase, the existence of these similar structures is not conducive to the full application of HZO-based ferroelectric memory.

Accurate determination of the crystal structure distribution inside these functional thin films is helpful to understand its working principle and is the basis for further process optimization. However, due to the small size of the device and the similarity of the crystal phase structures, it is often difficult to effectively distinguish via conventional macroscopic experimental methods. Spherical aberration corrected transmission electron microscopy (Cs-TEM) can obtain the microscopic morphology and structure in the three-dimensional space of the material. For example, high-resolution electron microscopy images (HREM), high-angle annular dark field images (HAADF) and annular bright field images (ABF) can give atomic arrangement variations at different positions of similar structures. For instance, the sliding of atomic layers between the bilayers when the face-centered cubic phase is transformed into the hexagonal phase in phase change memory; the atomic displacement within the unit cell when the ferroelectric O phase is transformed into the antiferroelectric T phase in ferroelectric memory. By identifying the arrangement characteristics of the atoms in the local region, the crystal structure can be accurately resolved at the nanoscale or even sub-nanoscale, without the need for a fast Fourier transform of the image. In recent years, the four-dimensional scanning transmission electron microscope (4D-STEM) technology appearing in Cs-TEM can record the convergent beam diffraction, nanobeam diffraction and Ronchigram of the corresponding sites while capturing real space images. Because these images are very sensitive to the crystal structure, thickness and tilt direction, the crystal structure can be directly determined by analyzing the overall characteristics of these images, the resolution depends on the step size of the electron probe and can reach the atomic scale.

Since the nanocrystalline crystal grains are randomly oriented in three-dimensional space, usually when using HREM, HAADF and other images for crystal phase identification, the theoretical image will be first obtained by transmission electron microscopy simulation software for comparison with experimental images for crystal phase identification. However, due to the random orientation and thickness of the crystal, it is inevitable to manually modify the crystal structure, orientation, thickness and other structural parameters of the simulation frequently, so the repetitive work is labor-intensive and time-consuming. Based on the mainstream programming software development platform of the computer system, the simulation software is implemented by setting the step size to traverse the simulation parameters, and a series of TEM simulation images are obtained as database files, which will greatly facilitate the subsequent image comparison tasks, where, the step size determines the precision of the database file.

Generally, the size of nanocrystalline grains is smaller than that of the whole device unit, a device usually contains several nanocrystalline grains, so it takes a long time to calibrate the crystal phase structure inside a device.

### SUMMARY

An objective of the present invention is to provide a machine learning method for identifying the crystal phase distribution of polycrystalline thin films in nanodevices, a series of transmission electron microscope simulation images are obtained as a database by adjusting the parameters of transmission electron microscope simulation software automatically. An individual deep learning convolution neural network is constructed according to the specific crystallographic parameters of polycrystalline functional thin films, such as crystal structure, tilt direction and sample thickness, respectively, which uses the transmission electron microscope image database as the data set to train the constructed neural network, when the neural network training is completed, the transmission electron microscope images of the grains at different positions in the actual polycrystalline functional thin film are analyzed to automatically, quickly and reliably identify the crystal phase distribution of the actual polycrystalline functional thin film.

The specific technical scheme for realizing the objective of the present invention is as follows:
a machine learning-assisted method for identifying the crystal phase distribution of polycrystalline thin films in nanodevices comprises the following steps:
step 1: establishing the corresponding atomic model according to the atomic arrangement of the constituent atoms in three-dimensional space in different crystal structures of the polycrystalline functional thin film;
step 2: importing the atomic model established in step 1 into a commercial or open-source simulation software for a transmission electron microscope image, and adjusting parameters according to recording conditions of an actual transmission electron microscope;
step 3: based on the mainstream programming software development platform of a computer system, taking the image simulation software used in step 2 as the development object, for different crystal structures, utilizing this image simulation software to traverse the tilt direction (1, φ, θ) represented in a three-dimensional spherical coordinate system and sample thickness parameters at a set step size. Then, execute the transmission electron microscope image simulation process to obtain a series of transmission electron microscope simulated images under different imaging modes and then saving automatically;
step 4: constructing N corresponding deep learning convolution neural networks in parallel for the N crystal phase parameters of polycrystalline functional thin films. Using a series of transmission electron microscope simulation images obtained in step 3 as the label data input set of a certain type of crystal phase parameter neural networks, and extracting the image features of the crystal phase parameter of M subcategories in the local region via machine learning; outputting the probabilities of the crystal phase parameters of different subcategories in the total M subcategories in the Softmax layer of the neural network, and obtaining the error based on the difference between the output value and the input label value; training the neural network again by using the error backpropagation to update the weights of the neural network until the error value is less than the set accuracy to complete the recognition training of the neural network; finally, adopting the same simulated image label data set to complete the neural network identification training of other crystal phase parameters;
step 5: fabricating nano-devices, such as phase change memory, ferroelectric memory, etc. via a standard semiconductor process, in which the thickness of the polycrystalline functional thin film is less than 30 nm, and verifying the performance via an electrical test system;
step 6: using a standard focused ion beam processing technology to prepare the device with good performance verified in step 5 into nanosheets;
step 7: observing the nanosheets prepared in step 6 in a transmission electron microscope, after adjusting the electron microscope state, select a suitable imaging mode to continuously capture microstructure images of different positions of the polycrystalline functional thin film in sequence;
step 8: when using the whole microstructure image taken in step 7 as the data input of the deep learning convolution neural network, directly performing the feature identification, and giving crystallographic parameters at different positions of the polycrystalline functional thin film through real-time processing. When taking the local microstructure image taken in step 7 as data input of the deep learning convolution neural network, firstly performing data storage and image grid segmentation operation on the whole picture, and then taking grid images at different positions in the picture successively as data input to perform feature identification so as to obtain crystallographic parameters at different positions of the polycrystalline functional thin film.

The machine learning-assisted method for identifying the crystal phase distribution of polycrystalline functional thin film in nanodevices, wherein in step 1, the established crystal structure model is the phase structure of the same composition in different states of the polycrystalline functional thin film.

The machine learning-assisted method for identifying the crystal phase distribution of polycrystalline functional thin film in nanodevices, wherein in step 2, the simulation parameters that need to be adjusted include acceleration voltage, spherical aberration, chromatic aberration, astigmatism, under-focus, exposure time, image size, and signal-to-noise ratio.

The machine learning-assisted method for identifying the crystal phase distribution of polycrystalline functional thin film in nanodevices, wherein in step 3, the simulated structure is the phase structure of the same composition in different states of the polycrystalline functional thin film.

The machine learning-assisted method for identifying the crystal phase distribution of polycrystalline functional thin film in nanodevices, wherein in step 3, the simulated sample thickness is 1-30 nm.

The machine learning-assisted method for identifying the crystal phase distribution of polycrystalline functional thin film in nanodevices, wherein in step 3, the images obtained by simulation may be high-resolution images, high-angle annular dark field images, annular bright field images, convergent beam diffraction images, nanobeam diffraction images, and Ronchigram images.

The machine learning-assisted method for identifying the crystal phase distribution of polycrystalline functional thin film in nanodevices, wherein in step 4, the crystal phase parameters requiring image recognition training include crystal structure, thickness and spatial orientation, etc.

The machine learning-assisted method for identifying the crystal phase distribution of polycrystalline functional thin film in nanodevices, wherein in step 4, the constructed deep learning convolution neural network can be AlexNet, ResNet or VGG model.

The machine learning-assisted method for identifying the crystal phase distribution of polycrystalline functional thin film in nanodevices, wherein in step 8, the imaging mode images in which the overall microstructure image is used as data input include convergent beam diffraction images, nanobeam diffraction images and Ronchigram images at different scanning positions in scanning transmission electron microscope mode inside transmission electron microscopy.

The machine learning-assisted method for identifying the crystal phase distribution of polycrystalline functional thin film in nanodevices, wherein in step 8, the imaging mode images with local microstructure image as data input include high-resolution images, high-angle annular dark field images and annular bright field images.

The beneficial effect of the present invention compared with the existing technology is: in the transmission electron microscope simulation software, a series of simulation images are automatically obtained as database files by traversing the simulation parameters. This process does not require manual frequent modification of the simulation parameters. Based on the convergent beam diffraction, nanobeam diffraction and Ronchigram as the input data of image recognition, the crystallographic parameters at different positions can be obtained in real-time, the accuracy depends on the step size of the electron probe, which can reach the atomic scale; the grid image based on HREM, HAADF or ABF is used as the input data of image recognition which is not necessary to perform data conversion operations such as fast Fourier transformation, the phase structure is distinguished by directly comparing the arrangement of atomic columns in the local area, so it has nanoscale or even atomic resolution. Machine learning is used to construct deep learning convolution neural networks for various crystal phase parameters such as crystal structure, crystal orientation, and thickness. The simulated HREM, HAADF or ABF transmission electron microscope images of polycrystalline functional material thin films are used as data sets to complete the training of neural networks, instead of manual means, automatically, quickly and reliably identify the crystal phase distribution of the actual polycrystalline functional thin film is realized.

The deep learning convolution neural network is constructed for the crystal structure, tilt direction, sample thickness and other crystallographic parameters of the polycrystalline functional thin film, the obtained microscopic simulated HREM, HAADF or ABF images are used as database files to identify the characteristics of the atomic arrangement of the neural network, after the training is completed, the phase structure of the film microstructure image taken by the actual TEM can be automatically calibrated quickly and reliably, and the crystal phase distribution inside the film can be obtained, the present invention will help to guide the subsequent optimization of nanodevices more quickly.

### BRIEF DESCRIPTION OF THE DRAWINGS

FIG. 1 is an atomic structural model of different crystal structures of a polycrystalline functional thin film;

FIG. 2 is a parameter setting interface of qstem image simulation software;

FIG. 3 is a typical HAADF image of different orientations simulated by the qstem image simulation software;

FIG. 4 is a flow chart of a deep learning convolution neural network AlexNet;

FIG. 5 is a device schematic diagram of a hafnium zirconium oxide ferroelectric capacitor;

FIG. 6 is a schematic diagram of a hafnium zirconium oxide ferroelectric thin film continuously photographed in a transmission electron microscope;

FIG. 7 shows the distribution of the grains to be detected in the hafnium zirconium oxide ferroelectric thin film;

### DETAILED DESCRIPTION OF THE EMBODIMENTS

The present invention will be described in detail below with reference to the particular examples.

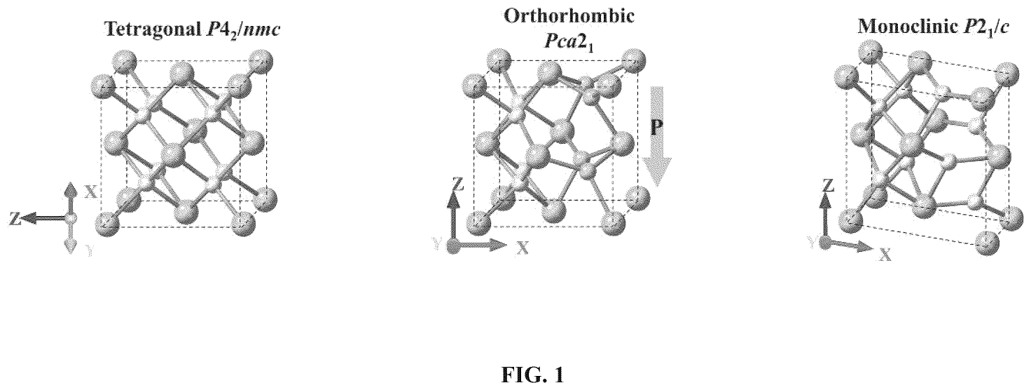

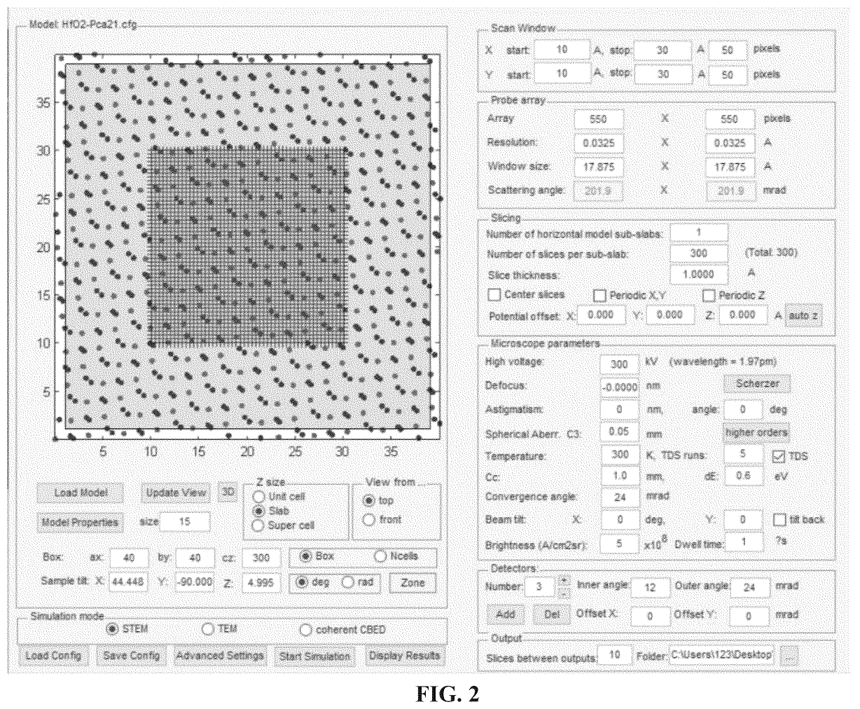

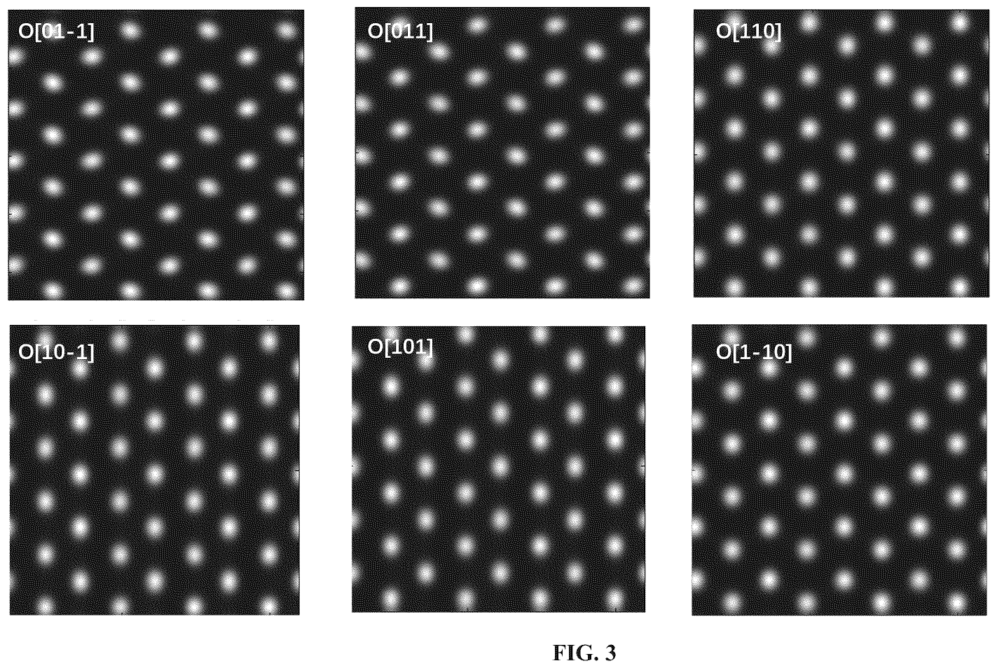

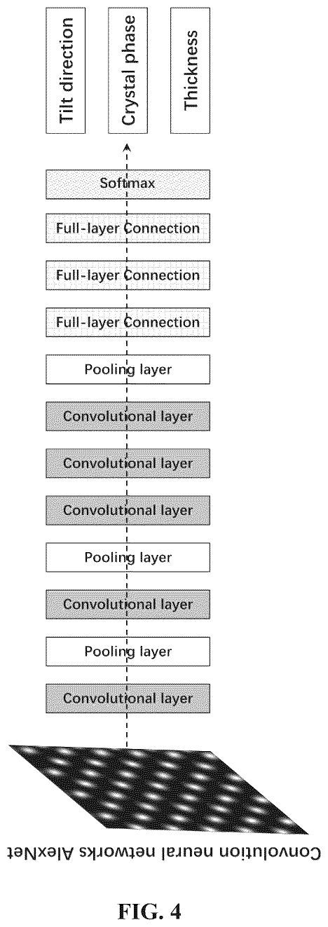

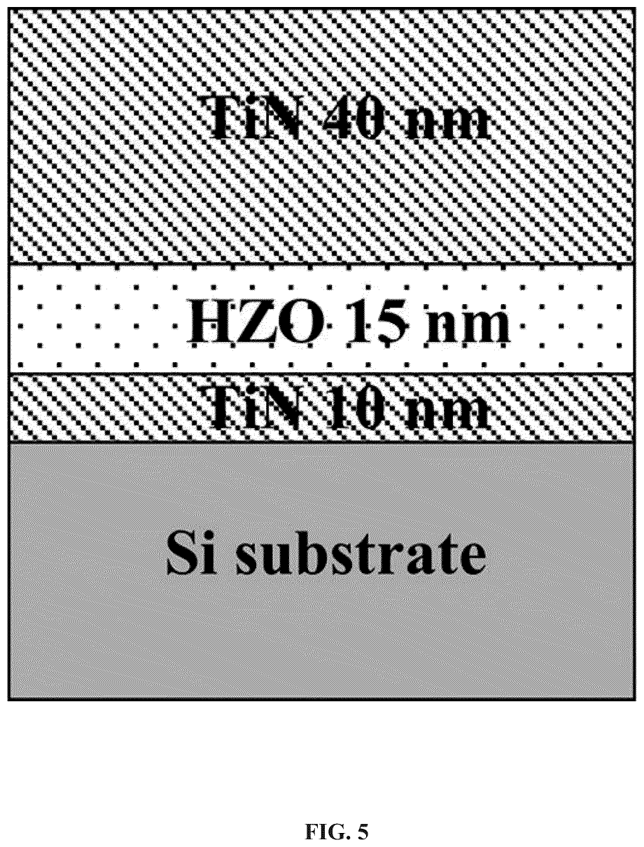

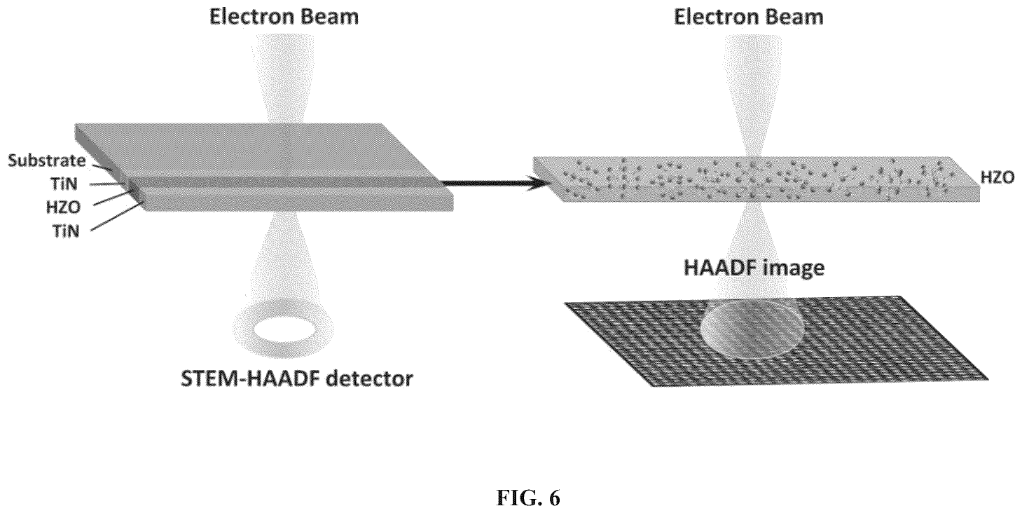

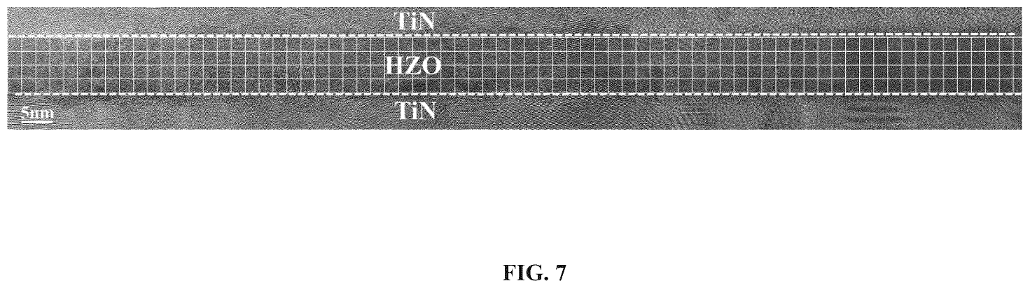

Refer to FIGS. 1-7, the present invention proposes a machine learning-assisted method for identifying the crystal phase distribution of polycrystalline functional thin film in nanodevices. By adjusting the simulation parameters of the transmission electron microscope simulation software automatically, a series of transmission electron microscope simulation images of nanocrystalline functional thin films are obtained as database files. A deep learning convolution neural network is constructed according to the crystallographic parameters of polycrystalline functional thin films, such as crystal structure, tilt direction and sample thickness, respectively, which is used to simulate the transmission electron microscope image database as the data set to train the constructed neural network, when the neural network training is completed, the transmission electron microscope images of grains at different positions in the actual polycrystalline functional films are identified the crystal phase distribution which comprises the following steps:
step 1: according to the atomic arrangement of anions and cations in the three-dimensional space of the orthorhombic phase (O), tetragonal phase (T) and monoclinic phase (M) of hafnium zirconium oxide (HZO) ferroelectric materials, the corresponding atomic model is established, as shown in FIG. 1.
Step 2: the atomic model established in step 1 is imported into an open-source Qstem software for a transmission electron microscope image simulation. Adjust the simulation parameters (acceleration voltage, spherical aberration, chromatic aberration, astigmatism, under-focus, exposure time, image size, and signal-to-noise ratio) according to the actual transmission electron microscope recording conditions, the parameter setting interface is shown in FIG. 2.
Step 3: based on the Python programming environment, the qstem simulation software is used as the development object. For different structures (O phase, T phase and M phase), the tilt direction (1, φ, θ) expressed in the three-dimensional spherical coordinate system and the sample thickness parameters (1-30 nm) are traversed with a set step size, and the subsequent transmission electron microscope image simulation operation process is executed in qstem software to obtain a series of high-angle annular dark field images (HAADF) simulation images and is automatically saved, the typical hafnium zirconium oxygen material HAADF image is shown in FIG. 3.
Step 4: three deep learning convolutional neural networks AlexNet are constructed in parallel for the crystal structure, tilt direction and sample thickness of hafnium-zirconium oxide materials, the corresponding network work flow chart is shown in FIG. 4. A series of HAADF simulation images obtained in step 3 are used as the label data input set, and the image features of three structures (O phase, T phase and M phase) in the local area are extracted by machine learning. The probability of the three structures of O phase, T phase and M phase is output in the Softmax layer of the neural network, and the error is obtained according to the output value and the input label value. The neural network is trained again by using the error backpropagation algorithm to update the weights of the neural network until the error value is less than the set accuracy to complete the recognition training of the neural network. Finally, the HAADF image label data set is used to complete the neural network identification training of the tilt direction and sample thickness.
Step 5: the bottom electrode, hafnium zirconium oxide thin film and top electrode were sequentially deposited on the silicon wafer substrate by mature atomic layer deposition process or pulsed laser deposition method, the hafnium zirconium oxide ferroelectric capacitor was obtained via a standard semiconductor process, the thickness of the hafnium zirconium oxide thin film is 1-20 nm, the schematic diagram of the capacitor structure is shown in FIG. 5.
Step 6: the ferroelectricity of hafnium zirconium oxide ferroelectric capacitors is verified by commercial ferroelectric tester.
Step 7: the hafnium zirconium oxide ferroelectric capacitors are prepared into nanosheets with a thickness of less than 20 nm by a standard focused ion beam processing process.
Step 8: the hafnium zirconium oxide nanosheets prepared in step 7 are observed in a transmission electron microscope, and after the electron microscope state is adjusted (acceleration voltage, magnification, exposure time, image size), the microstructure images of hafnium zirconium oxide films at different positions are successively photographed under the same recording conditions in the HAADF image mode inside transmission electron microscope, as shown in FIG. 6.
Step 9: after the HAADF image obtained by step 8 is saved, the image is further divided into grids, as shown in FIG. 7. The grid images at different positions in the images are input to the deep learning convolution neural network trained in step 4 as images to be detected. Characteristics identification of crystallographic parameters was carried out to obtain the thin film thickness, crystal structure and crystal orientation at different positions in hafnium zirconium oxygen.

In summary, this example proposes a machine learning-assisted method for identifying the crystal phase distribution of polycrystalline functional thin film in nanodevices. By adjusting the simulation parameters of the transmission electron microscope simulation software automatically, a series of transmission electron microscope simulation images of nanocrystalline functional thin films are obtained as a database. Construct separate deep learning convolution neural networks for the crystallographic parameters of the actual polycrystalline functional thin films, such as crystal structure, tilt direction and sample thickness, etc., which use simulated transmission electron microscope image database as the data set to train the constructed neural network. The trained neural network is used to judge the characteristics of the transmission electron microscope images of the grains at different positions in the actual polycrystalline functional material film, and the automatic identification task of the crystal phase distribution is completed.

It should be understood that ordinary technicians in this field can be improved or transformed according to the above description, and all these improvements and transformations should belong to the scope of protection of the claims attached to the present invention.

What is claimed is:

1. A machine learning method for identifying the crystal phase distribution of polycrystalline thin films in nanodevices, comprises the following steps:
step 1: establishing the corresponding atomic model according to the atomic arrangement of the constituent atoms in three-dimensional space in different crystal structures of the polycrystalline functional thin film;
step 2: importing the atomic model established in step 1 into a commercial or open-source simulation software for a transmission electron microscope image, and adjusting parameters according to recording conditions of an actual transmission electron microscope;
step 3: based on the mainstream programming software development platform of a computer system, taking the image simulation software used in step 2 as the development object, for different crystal structures, utilizing this image simulation software to traverse the tilt direction (1, φ, θ) represented in a three-dimensional spherical coordinate system and sample thickness parameters at a set step size, then, execute the transmission electron microscope image simulation process to obtain a series of transmission electron microscope simulated images under different imaging modes and then saving automatically;
step 4: constructing N corresponding deep learning convolution neural networks in parallel for the N crystal phase parameters of polycrystalline functional thin films; using a series of transmission electron microscope simulation images obtained in step 3 as the label data input set of a certain type of crystal phase parameter neural networks, and extracting the image features of the crystal phase parameter of M subcategories in the local region via machine learning; outputting the probabilities of the crystal phase parameters of different subcategories in the total M subcategories in the Softmax layer of the neural network, and obtaining the error based on the difference between the output value and the input label value; training the neural network again by using the error backpropagation to update the weights of the neural network until the error value is less than the set accuracy to complete the recognition training of the neural network; finally, adopting the same simulated image label data set to complete the neural network identification training of other crystal phase parameters;
step 5: fabricating nano-devices, such as phase change memory, ferroelectric memory, etc. via a standard semiconductor process, in which the thickness of the polycrystalline functional thin film is less than 30 nm, and verifying the performance via an electrical test system;
step 6: using a standard focused ion beam processing technology to prepare the device with a good performance verified in step 5 into a nanosheet;
step 7: observing the nanosheets prepared in step 6 in a transmission electron microscope, after adjusting the electron microscope state, select a suitable imaging mode to continuously capture microstructure images of different positions of the polycrystalline functional thin film in sequence;
step 8: when using the whole microstructure image taken in step 7 as the data input of the deep learning convolution neural network, directly performing the feature identification, and giving crystallographic parameters at different positions of the polycrystalline functional thin film through real-time processing; when taking the local microstructure image taken in step 7 as data input of the deep learning convolution neural network, firstly performing data storage and image grid segmentation operation on the whole picture, and then taking grid images at different positions in the picture successively as data input to perform feature identification so as to obtain crystallographic parameters at different positions of the polycrystalline functional thin film.

2. The machine learning-assisted method for identifying the crystal phase distribution of polycrystalline functional thin film in nanodevices according to claim 1, wherein in step 1, the established crystal structure model is the phase structure of the same composition in different states of the polycrystalline functional thin film.

3. The machine learning-assisted method for identifying the crystal phase distribution of polycrystalline functional thin film in nanodevices according to claim 1, wherein in step 2, the simulation parameters that need to be adjusted include acceleration voltage, spherical aberration, chromatic aberration, astigmatism, under-focus, exposure time, image size, and signal-to-noise ratio.

4. The machine learning-assisted method for identifying the crystal phase distribution of polycrystalline functional thin film in nanodevices according to claim 1, wherein in step 3, the simulated structure is the phase structure of the same composition in different states of the polycrystalline functional thin film.

5. The machine learning-assisted method for identifying the crystal phase distribution of polycrystalline functional thin film in nanodevices according to claim 1, wherein in step 3, the simulated sample thickness is 1-30 nm.

6. The machine learning-assisted method for identifying the crystal phase distribution of polycrystalline functional thin film in nanodevices according to claim 1, wherein in step 3, the images obtained by simulation may be high-resolution images, high-angle annular dark field images, annular bright field images, convergent beam diffraction images, nanobeam diffraction images, and Ronchigram images.

7. The machine learning-assisted method for identifying the crystal phase distribution of polycrystalline functional thin film in nanodevices according to claim 1, wherein in step 4, the crystal phase parameters requiring image recognition training include crystal structure, thickness and spatial orientation, etc.

8. The machine learning-assisted method for identifying the crystal phase distribution of polycrystalline functional thin film in nanodevices according to claim 1, wherein in step 4, the constructed deep learning convolution neural network can be AlexNet, ResNet or VGG model.

9. The machine learning-assisted method for identifying the crystal phase distribution of polycrystalline functional thin film in nanodevices according to claim 1, wherein in step 8, the imaging mode images in which the overall microstructure image is used as data input include convergent beam diffraction images, nanobeam diffraction images and Ronchigram images at different scanning positions in scanning transmission electron microscope mode inside transmission electron microscopy.

10. The machine learning-assisted method for identifying the crystal phase distribution of polycrystalline functional thin film in nanodevices according to claim 1, wherein in step 8, the imaging mode images with local microstructure image as data input include high-resolution images, high-angle annular dark field images and annular bright field images.
